(19) United States
(12) Patent Application Publication
(10) Pub. No.: US 2011/0095584 A1
(43) Pub. Date: Apr. 28, 2011

(54) SEAT APPARATUS

(75) Inventors: Masahiro TOMIDA, Aichi (JP); Kiyoyuki KOJIMA, Aichi (JP); Hiroyuki UEKI, Aichi (JP)

(73) Assignee: IMASEN ELECTRIC INDUSTRIAL CO., LTD., Aichi (JP)

(21) Appl. No.: 12/913,026

(22) Filed: Oct. 27, 2010

(30) Foreign Application Priority Data
Oct. 28, 2009 (JP) 2009-247187

(51) Int. Cl. B60N 2/02; B60N 2/06; B60N 2/22

(52) U.S. Cl. 297/330; 74/89.14

(57) ABSTRACT

An object of the present invention is to provide a seat apparatus enabling noise reduction and size reduction of a rotation transmitting mechanism. This seat apparatus is provided with a rotation transmitting mechanism capable of transmitting rotation to each of adjusting mechanisms. This rotation transmitting mechanism includes a motor, a worm, and two worm wheels each meshed with the worm and arranged in proximity to each other. This rotation transmitting mechanism also includes four clutch members. Each clutch member is interposed between corresponding one of the adjusting mechanisms and corresponding one of the worm wheels. Each clutch member is configured such that it can be switched between a transmission state and an interruption state. In the transmission state, rotation via the worm wheel can be transmitted to the corresponding adjusting mechanism. In the interruption state, on the other hand, transmission of the rotation is interrupted.

### CROSS-REFERENCE TO RELATED APPLICATION

This application is based on Japanese Patent Application No. 2009-247187 filed with the Japan Patent Office on Oct. 28, 2009, the entire content of which is hereby incorporated by reference.

### BACKGROUND

1. Technical Field

The present invention relates to an electric seat apparatus.

2. Related Art

An example of a conventional electric seat apparatus is a vehicle seat disclosed in Patent Document 1 listed below. This vehicle seat has four output shafts in a gear case as a rotation transmitting mechanism. This seat is configured to perform front-back movement of the entire seat, inclination of a backrest, vertical movement of the front half of a seat cushion, and vertical movement of the rear half of the seat cushion in response to respective rotations from these output shafts. The gear case incorporates a motor, a transmission belt wound around a motor shaft of the motor, and four clutches. These clutches can be switched whether or not rotation from the transmission belt is transmitted to the corresponding output shaft via a spur gear (pulley). In this apparatus, in a case where the entire seat is to be moved in the front-back direction, for example, only the corresponding clutch is switched to a transmission state. In this manner, a desired operation is performed.

The document that describes the related art is shown below.

Patent Document 1: Japanese Patent Application Laid-Open No. 06-087363

In the rotation transmitting mechanism configured as described above, each spur gear and the transmission belt are meshed with each other and rotate at all times, which causes a noise problem. Also, in order to cause the transmission belt to be meshed with each spur gear, each spur gear needs to be arranged along the longitudinal direction of the transmission belt. This makes it difficult to reduce the size of the rotation transmitting mechanism.

### SUMMARY

An object of an aspect according to the present invention is to provide a seat apparatus enabling noise reduction and size reduction of a rotation transmitting mechanism.

A seat apparatus according to a first aspect of the present invention includes a seat cushion slidably attached to a vehicle body, a seat back inclinably attached to a rear portion of the seat cushion, a first adjusting mechanism which adjusts a sliding amount of the seat cushion with respect to the vehicle body in accordance with rotation to be transmitted, a second adjusting mechanism which adjusts an inclination angle of the seat back with respect to the seat cushion in accordance with rotation to be transmitted, a third adjusting mechanism which adjusts a height of a front portion of the seat cushion in accordance with rotation to be transmitted, a fourth adjusting mechanism which adjusts a height of the rear portion of the seat cushion in accordance with rotation to be transmitted, and a rotation transmitting mechanism capable of transmitting the rotation to each of the adjusting mechanisms, and the rotation transmitting mechanism includes the motor, a worm which rotates in accordance with rotation driving of the motor, a plurality of worm wheels each meshed with the worm and arranged in proximity to one another, and four clutch members each of which is interposed between corresponding one of the adjusting mechanisms and corresponding one of the plurality of worm wheels and can be switched between a transmission state where rotation via the worm wheel can be transmitted to the corresponding adjusting mechanism and an interruption state where transmission of the rotation is interrupted.

A seat apparatus according to a second aspect of the present invention is a seat apparatus wherein, in the seat apparatus according to the first aspect, two of the four clutch members are respectively arranged on one side and the other side in an axial direction of the one worm wheel so as to be each interposed between corresponding one of the adjusting mechanisms and the worm wheel.

The seat apparatus according to the first aspect is provided with the rotation transmitting mechanism capable of transmitting the rotation to each of the adjusting mechanisms. This rotation transmitting mechanism includes the motor, the worm, and the plurality of worm wheels each meshed with the worm and arranged in proximity to one another. This rotation transmitting mechanism also includes the four clutch members. Each clutch member is configured such that it can be switched between the transmission state and the interruption state. Each clutch member is interposed between corresponding one of the adjusting mechanisms and corresponding one of the plurality of worm wheels. In the transmission state, rotation via the worm wheel can be transmitted to the corresponding adjusting mechanism. In the interruption state, on the other hand, transmission of the rotation is interrupted.

Accordingly, rotation generated at the motor is transmitted to any one of the adjusting mechanisms via the worm and any one of the worm wheels. This enables noise reduction of the rotation transmitting mechanism, compared with a case of transmission via a spur gear or the like. Also, each worm wheel can be meshed with the worm as long as its rotation axis is perpendicular to the rotation axis of the worm. Thus, the respective worm wheels can be arranged in proximity to each other without being aligned in a predetermined direction. This enables size reduction of the rotation transmitting mechanism, compared with a case of providing a transmission belt or the like.

In the seat apparatus according to the second aspect, two of the four clutch members are respectively arranged on one side and the other side in an axial direction of one worm wheel so as to be each interposed between corresponding one of the adjusting mechanisms and the worm wheel. In this configuration, one worm wheel is used in common by two clutch members. This reduces the required number of worm wheels, which enables further size reduction of the rotation transmitting mechanism.

### BRIEF DESCRIPTION OF THE DRAWINGS

The foregoing and other objects, features, aspects and advantages of the invention will become more apparent from the following detailed description when taken in conjunction with the accompanying drawings, in which:

FIG. 1 is a side view schematically showing an example of a seat apparatus according to an aspect of the present invention;

FIG. 2 is a block diagram showing a connection relationship between a rotation transmitting mechanism and each adjusting mechanism;

FIG. 3 is a perspective view showing a worm meshed with each of worm wheels;

FIG. 4 is a side view showing the worm meshed with each of the worm wheels; and

FIG. 5 is a cross-sectional view showing a cross-section corresponding to line 5-5 shown in FIG. 4.

### DESCRIPTION OF EMBODIMENTS

Preferred embodiments of the present invention will be described below with reference to the accompanying drawings, in which like reference characters designate similar or identical parts throughout the several views thereof.

Hereinafter, an embodiment of a seat apparatus 10 for vehicles according to an aspect of the present invention will be described with reference to the drawings.

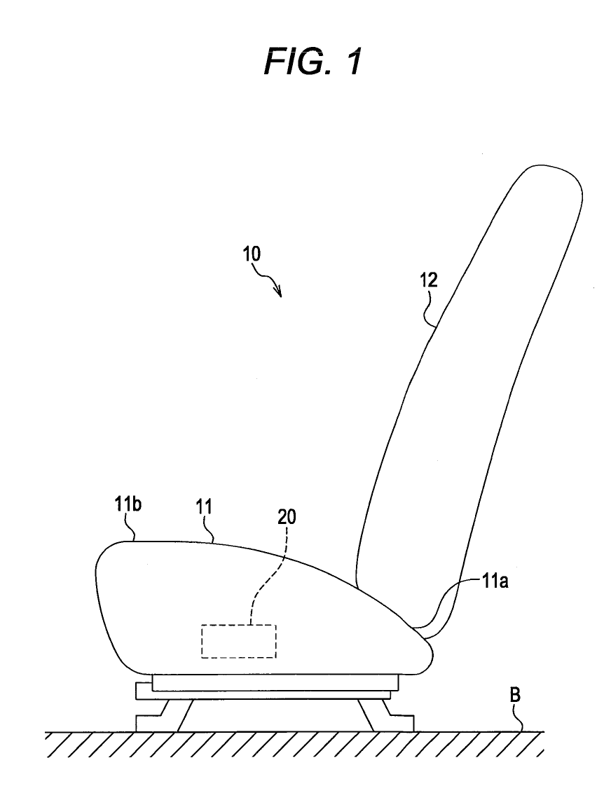

The seat apparatus 10 includes a seat cushion 11 receiving a sitter's hip and a seat back 12 receiving the sitter's back as shown in FIG. 1. The seat cushion 11 is slidably attached to a vehicle body B. The seat back 12 is inclinably attached to a rear portion 11 a of the seat cushion 11.

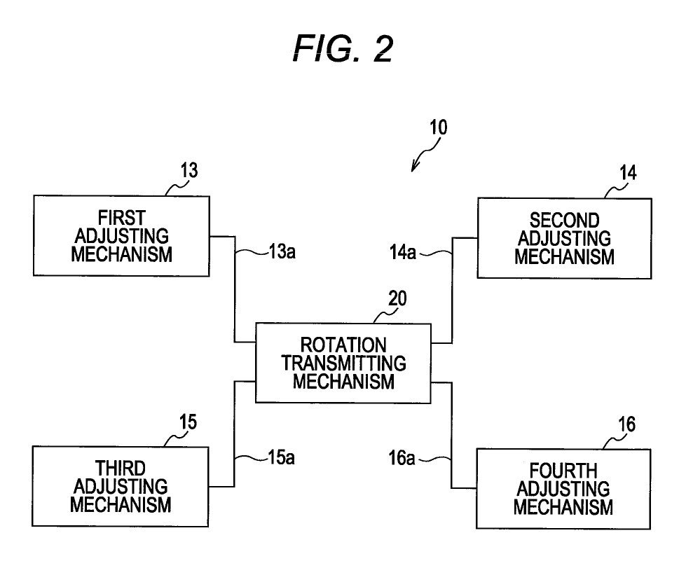

Also, the seat apparatus 10 includes four adjusting mechanisms 13 to 16 and a rotation transmitting mechanism 20 as shown in FIG. 2. The rotation transmitting mechanism 20 can transmit rotation to each of the adjusting mechanisms 13 to 16 via transmission cables 13a to 16a. The first adjusting mechanism 13 is provided between the seat cushion 11 and the vehicle body B. This first adjusting mechanism 13 is configured to enable adjustment of the sliding amount of the seat cushion 11 with respect to the vehicle body B in accordance with rotation to be transmitted. The second adjusting mechanism 14 is provided between the seat cushion 11 and the seat back 12. This second adjusting mechanism 14 is configured to enable adjustment of the inclination angle of the seat back 12 with respect to the seat cushion 11 in accordance with rotation to be transmitted. The third adjusting mechanism 15 is arranged near a front portion 11b of the seat cushion 11. This third adjusting mechanism 15 is configured to enable adjustment of the height of the front portion 11b of the seat cushion 11 in accordance with rotation to be transmitted. The fourth adjusting mechanism 16 is arranged near the rear portion 11a of the seat cushion 11. This fourth adjusting mechanism 16 is configured to enable adjustment of the height of the rear portion 11a of the seat cushion 11 in accordance with rotation to be transmitted.

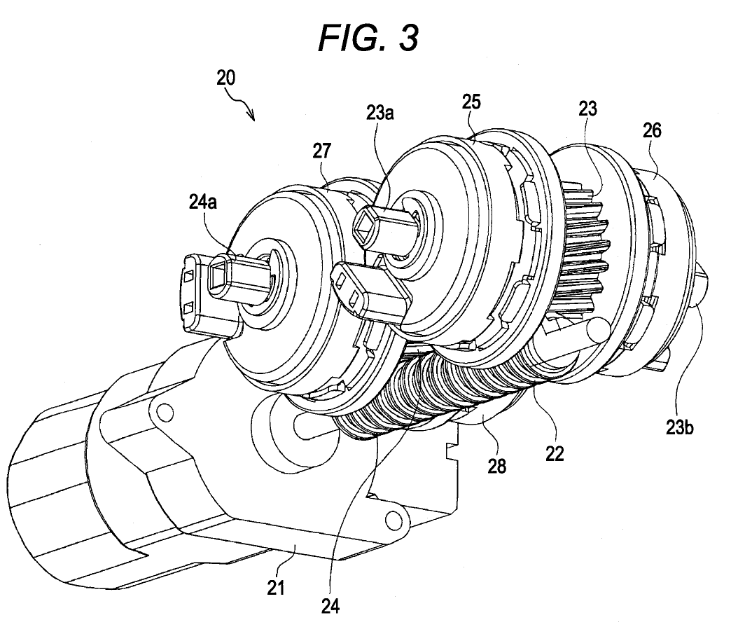

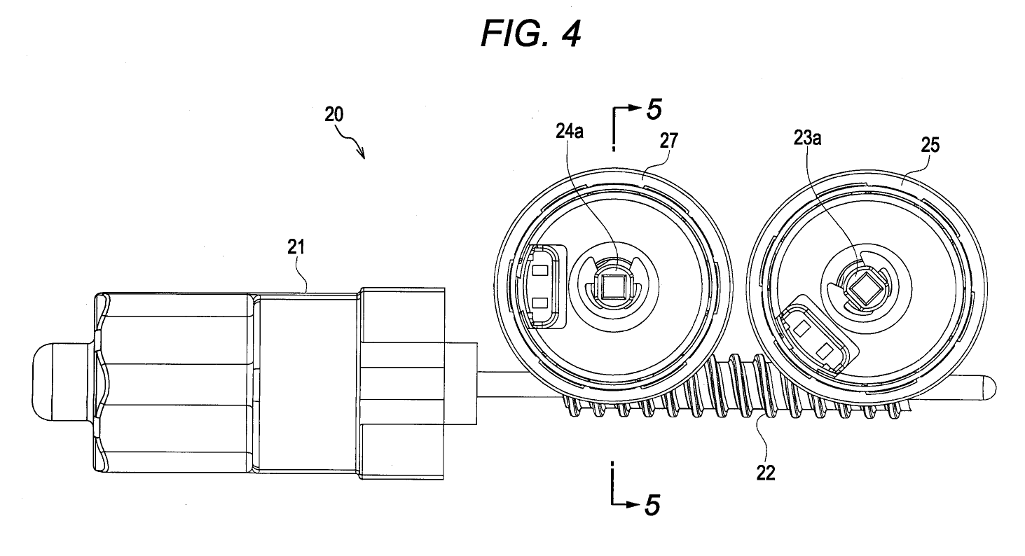

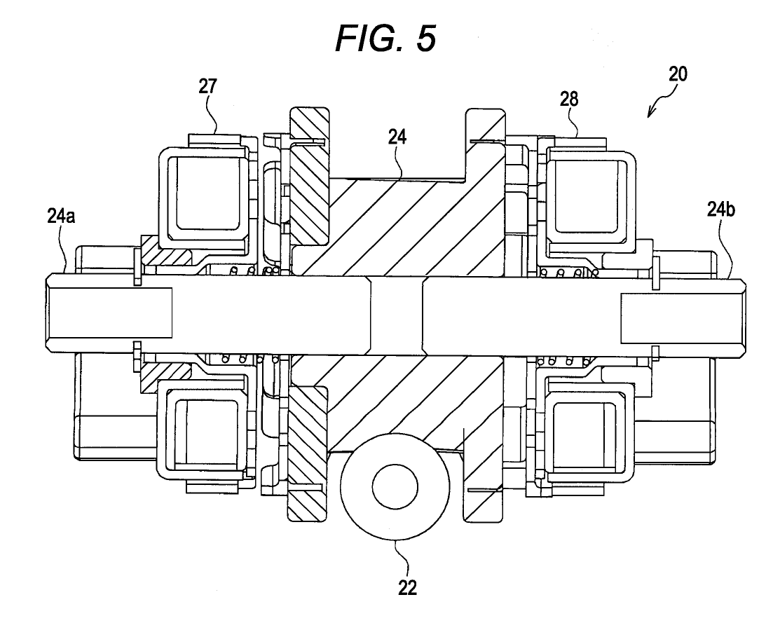

The rotation transmitting mechanism 20 is provided between the seat cushion 11 and the vehicle body B. The rotation transmitting mechanism 20 includes a motor 21, a worm 22, two worm wheels 23 and 24, and four clutch members 25 to 28 as shown in FIGS. 3 to 5. The motor 21 and the respective clutch members 25 to 28 are configured to perform an after-mentioned operation in response to a signal from a driving circuit or the like of a control unit (not shown) in accordance with a predetermined manipulation of a manipulation switch (not shown).

The motor 21 is adapted to generate the aforementioned rotation in response to the signal from the aforementioned driving circuit. Its motor shaft is provided with the worm 22 that rotates in accordance with the rotation driving of the motor 21. The first worm wheel 23 and the second worm wheel 24 are each meshed with the upper side portion of the worm 22. These worm wheels 23 and 24 are arranged in proximity to each other so that the respective rotation axes may be parallel.

The first clutch member 25 is attached to a rotation axis 23a on one side of the first worm wheel 23 so as to be interposed between the corresponding first adjusting mechanism 13 and the first worm wheel 23. This first clutch member 25 is configured such that it can be switched between a transmission state and an interruption state in accordance with a control signal to be input from the aforementioned control unit. In the transmission state, rotation via the first worm wheel 23 can be transmitted to the first adjusting mechanism 13. In the interruption state, on the other hand, transmission of the rotation is interrupted.

The second clutch member 26 is attached to a rotation axis 23b on the other side of the first worm wheel 23 so as to be interposed between the corresponding second adjusting mechanism 14 and the first worm wheel 23. This second clutch member 26 is configured such that it can be switched between a transmission state and an interruption state in accordance with the control signal to be input from the aforementioned control unit. In the transmission state, rotation via the first worm wheel 23 can be transmitted to the second adjusting mechanism 14. In the interruption state, on the other hand, transmission of the rotation is interrupted. That is, the first clutch member 25 and the second clutch member 26 are respectively arranged on one side and the other side in the axial direction of the common worm wheel (the first worm wheel 23). The first clutch member 25 and the second clutch member 26 are each arranged so as to be interposed between corresponding one of the adjusting mechanisms (the first adjusting mechanism 13 and the second adjusting mechanism 14) and the first worm wheel 23.

The third clutch member 27 is attached to a rotation axis 24a on one side of the second worm wheel 24 so as to be interposed between the corresponding third adjusting mechanism 15 and the second worm wheel 24. This third clutch member 27 is configured such that it can be switched between a transmission state and an interruption state in accordance with the control signal to be input from the aforementioned control unit. In the transmission state, rotation via the second worm wheel 24 can be transmitted to the third adjusting mechanism 15. In the interruption state, on the other hand, transmission of the rotation is interrupted.

The fourth clutch member 28 is attached to a rotation axis 24b on the other side of the second worm wheel 24 so as to be interposed between the corresponding fourth adjusting mechanism 16 and the second worm wheel 24. This fourth clutch member 28 is configured such that it can be switched between a transmission state and an interruption state in accordance with the control signal to be input from the aforementioned control unit. In the transmission state, rotation via the second worm wheel 24 can be transmitted to the fourth adjusting mechanism 16. In the interruption state, on the other hand, transmission of the rotation is interrupted. That is, the third clutch member 27 and the fourth clutch member 28 are respectively arranged on one side and the other side in the axial direction of the common worm wheel (the second worm wheel 24). The third clutch member 27 and the fourth clutch member 28 are each arranged so as to be interposed between corresponding one of the adjusting mechanisms (the third adjusting mechanism 15 and the fourth adjusting mechanism 16) and the second worm wheel 24.

Next, operations of the rotation transmitting mechanism 20 configured as described above will be described.

When a predetermined manipulation to slide the seat cushion 11 to a desired sliding position is performed to the aforementioned manipulation switch by a user, the motor 21 is rotationally driven in response to the signal from the aforementioned control unit. In addition, in response to this signal, only the first clutch member 25 is in the transmission state while the other clutch members 26 to 28 are in the interruption state. Thus, when the worm 22 is rotated in accordance with the rotation driving of the motor 21, rotation from the first worm wheel 23 meshed with this worm 22 is transmitted to the first adjusting mechanism 13 via the first clutch member 25 in the transmission state and the transmission cable 13a. This causes the seat cushion 11 to slide toward the desired sliding position.

Also, when a predetermined manipulation to change the inclination angle of the seat back 12 with respect to the seat cushion 11 to a desired angle is performed to the aforementioned manipulation switch by the user, the motor 21 is rotationally driven in response to the signal from the aforementioned control unit. In addition, in response to this signal, only the second clutch member 26 is in the transmission state while the other clutch members 25, 27, and 28 are in the interruption state. Thus, when the worm 22 is rotated in accordance with the rotation driving of the motor 21, rotation from the first worm wheel 23 meshed with this worm 22 is transmitted to the second adjusting mechanism 14 via the second clutch member 26 in the transmission state and the transmission cable 14a. This causes the seat back 12 to be inclined at the desired inclination angle.

Further, when the aforementioned manipulation switch is manipulated by the user to change the height of the front portion 11b of the seat cushion 11 to a desired height, the motor 21 is rotationally driven in response to the signal from the aforementioned control unit. In addition, in response to this signal, only the third clutch member 27 is in the transmission state while the other clutch members 25, 26, and 28 are in the interruption state. Thus, when the worm 22 is rotated in accordance with the rotation driving of the motor 21, rotation from the second worm wheel 24 meshed with this worm 22 is transmitted to the third adjusting mechanism 15 via the third clutch member 27 in the transmission state and the transmission cable 15a. This causes the front portion 11b of the seat cushion 11 to move to the desired height.

Still further, when the aforementioned manipulation switch is manipulated by the user to change the height of the rear portion 11a of the seat cushion 11 to a desired height, the motor 21 is rotationally driven in response to the signal from the aforementioned control unit. In addition, in response to this signal, only the fourth clutch member 28 is in the transmission state while the other clutch members 25 to 27 are in the interruption state. Thus, when the worm 22 is rotated in accordance with the rotation driving of the motor 21, rotation from the second worm wheel 24 meshed with this worm 22 is transmitted to the fourth adjusting mechanism 16 via the fourth clutch member 28 in the transmission state and the transmission cable 16a. This causes the rear portion 11a of the seat cushion 11 to move to the desired height.

As described above, the seat apparatus 10 according to the present embodiment is provided with the rotation transmitting mechanism 20 that can transmit rotation to each of the adjusting mechanisms 13 to 16. This rotation transmitting mechanism 20 includes the motor 21 and the worm 22. This rotation transmitting mechanism 20 also includes the two worm wheels 23 and 24. These worm wheels 23 and 24 are each meshed with the worm 22 and are arranged in proximity to each other. This rotation transmitting mechanism 20 further includes the four clutch members 25 to 28. Each of these clutch members is interposed between corresponding one of the adjusting mechanisms 13 to 16 and corresponding one of the worm wheels 23 and 24. Each of the clutch members is configured such that it can be switched between the transmission state and the interruption state. In the transmission state, rotation via the corresponding worm wheel can be transmitted to the corresponding adjusting mechanism. In the interruption state, on the other hand, transmission of the rotation is interrupted.

Accordingly, rotation generated at the motor 21 is transmitted to any one of the adjusting mechanisms 13 to 16 via the worm 22 and any one of the worm wheels 23 and 24. This enables noise reduction of the rotation transmitting mechanism 20, compared with a case of transmission via a spur gear or the like. Also, the worm wheels 23 and 24 are each meshed with the upper side portion of the worm 22 and are arranged in proximity to each other so that the respective rotation axes may be parallel. This enables size reduction of the rotation transmitting mechanism 20, compared with a case of providing a transmission belt or the like.

Also, in the seat apparatus 10 according to the present embodiment, the first clutch member 25 and the second clutch member 26 are respectively arranged on one side and the other side in the axial direction of the first worm wheel 23. The first clutch member 25 and the second clutch member 26 are each arranged so as to be interposed between corresponding one of the adjusting mechanisms 13 and 14 and the first worm wheel 23. The third clutch member 27 and the fourth clutch member 28 are respectively arranged on one side and the other side in the axial direction of the second worm wheel 24. The third clutch member 27 and the fourth clutch member 28 are each arranged so as to be interposed between corresponding one of the adjusting mechanisms 15 and 16 and the second worm wheel 24. In this configuration, one worm wheel is used in common by two clutch members. This reduces the required number of worm wheels, which enables further size reduction of the rotation transmitting mechanism 20.

Note that the present invention is not limited to the above embodiment. The present invention may be embodied to have the following configurations. These configurations also exert equivalent functions and effects to those of the above embodiment.

(1) The worm wheels can be meshed with the worm as long as their rotation axes are perpendicular to the rotation axis of the worm. Thus, the respective worm wheels 23 and 24 may be arranged in accordance with a permissible space. For example, the first worm wheel 23 may be meshed with the upper side portion of the worm 22 while the second worm wheel 24 may be meshed with the lower side portion of the worm 22. That is, the respective worm wheels 23 and 24 may be arranged in proximity to each other without being aligned in a predetermined direction (the axial direction of the worm 22).

(2) Three or four worm wheels may be meshed with the worm 22 in accordance with a permissible space. In a case of using three worm wheels, one of them is provided with two clutch members, and each of the rest with one clutch member. In a case of using four worm wheels, each worm wheel is provided with one clutch member.

While the invention has been illustrated and described in detail, the foregoing description is in all aspects illustrative and not restrictive. It is therefore understood that numerous modifications and variations can be devised without departing from the spirit and scope of the invention.

What is claimed is:

1. A seat apparatus comprising:
a seat cushion slidably attached to a vehicle body;
a seat back inclinably attached to a rear portion of the seat cushion;
a first adjusting mechanism which adjusts a sliding amount of the seat cushion with respect to the vehicle body in accordance with rotation to be transmitted;
a second adjusting mechanism which adjusts an inclination angle of the seat back with respect to the seat cushion in accordance with rotation to be transmitted;
a third adjusting mechanism which adjusts a height of a front portion of the seat cushion in accordance with rotation to be transmitted;
a fourth adjusting mechanism which adjusts a height of the rear portion of the seat cushion in accordance with rotation to be transmitted; and
a rotation transmitting mechanism capable of transmitting the rotation to each of the adjusting mechanisms,
wherein the rotation transmitting mechanism includes:
the motor;
a worm which rotates in accordance with rotation driving of the motor;
a plurality of worm wheels each meshed with the worm and arranged in proximity to one another; and
four clutch members each of which is interposed between corresponding one of the adjusting mechanisms and corresponding one of the plurality of worm wheels and can be switched between a transmission state where rotation via the worm wheel can be transmitted to the corresponding adjusting mechanism and an interruption state where transmission of the rotation is interrupted.

2. The seat apparatus according to claim 1, wherein two of the four clutch members are respectively arranged on one side and the other side in an axial direction of the one worm wheel so as to be each interposed between corresponding one of the adjusting mechanisms and the worm wheel.

3. A seat adjusting unit comprising:
a plurality of adjusting mechanisms to adjust arrangement of a seat provided in a vehicle; and
a driving force transmitting mechanism to transmit rotation of a motor to these adjusting mechanisms,
wherein the driving force transmitting mechanism includes:
a worm which rotates in accordance with rotation of the motor;
a worm wheel which is meshed with the worm and rotates in accordance with rotation of the worm; and
a clutch member which is provided for each of the adjusting mechanisms and can be switched between a transmission state where rotation of the worm wheel is transmitted to the corresponding adjusting mechanism and an interruption state where transmission of the rotation is interrupted.

4. The seat adjusting unit according to claim 3, wherein two of the clutch members are arranged to sandwich the one worm wheel.

5. The seat adjusting unit according to claim 4, wherein a plurality of the worm wheels are provided and arranged in proximity to one another.

6. The seat adjusting unit according to claim 5, wherein rotation axes of the plurality of worm wheels are parallel to one another.

7. The seat adjusting unit according to claim 6, wherein two worm wheels and four clutch members are provided, and
the adjusting mechanisms each corresponding to each clutch member include:
a first adjusting mechanism which adjusts a sliding amount of the seat;
a second adjusting mechanism which adjusts an inclination angle of a seat back provided at a rear portion of the seat;
a third adjusting mechanism which adjusts a height of a front portion of the seat; and
a fourth adjusting mechanism which adjusts a height of the rear portion of the seat.

8. A seat apparatus comprising a seat and the seat adjusting unit according to claim 1.
